(19) United States
(12) Patent Application Publication
(10) Pub. No.: US 2007/0280276 A1
(43) Pub. Date: Dec. 6, 2007

(54) Method and apparatus for managing client layer communications services

(75) Inventors: Jonathan B. Sadler, Naperville, IL (US); T. Benjamin Mack-Crane, Downers Grove, IL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL (US)

(21) Appl. No.: 11/641,303

(22) Filed: Dec. 19, 2006

Related U.S. Application Data
(63) Continuation-in-part of application No. 11/443,499, filed on May 30, 2006.

(51) Int. Cl. H04L 12/56

(52) U.S. Cl. 370/408; 370/392; 370/235

(57) ABSTRACT

An example embodiment of the present invention is a method of managing network communications layers on a network. The example embodiment (i) selects nodes in a network normally configured with server layer resources (e.g., SONET/SDH) to support client communications on a communications path between source nodes and destination nodes and (ii) instantiates client layer resources (e.g., Ethernet or IP) to support communications at branch nodes among the selected nodes at which communications paths from a common source node split to take different paths toward different destination nodes or at which communications paths toward a common destination node merge from different source nodes. Dynamic configuration of client layer resources is thus provided, and the given node may operate in an autonomous manner, instantiating client layer resources on an as needed basis.

### RELATED APPLICATION

This application is a Continuation-in-Part of U.S. application Ser. No. 11/443,499, filed on May 30, 2006, entitled “Method and Apparatus for Managing Client Layer Communications Services.” The entire teachings of the above application are incorporated herein by reference.

### BACKGROUND OF THE INVENTION

In a network predominately consisting of a ubiquitous transmission technology, (e.g., layer 1) such as Synchronous Optical Network (SONET) layer communications, a service provider may want to provide switched transport services based on different technologies (e.g., layer 2, such as Ethernet, or layer 3, such as Internet Protocol (IP)) that are layered on top of the transmission technology. The relationship between these technologies is a client/server relationship, where the transmission technology is a server layer providing a service connecting intermediate switching points operating in the client layer. In such cases, the service provider will need to identify the network nodes at which to locate client layer resource(s) (e.g. switching functions, like an Ethernet bridge). However, in many cases the client layer switching functions are finite resources. As a result, using a client layer resource reduces availability for other client layer service requests. Therefore, the service provider typically identifies a subset of possible nodes at which to deploy the client layer resources so as not to use client layer resources wastefully.

An existing way to solve this problem is through offline optimization. In offline optimization, a client layer service provider knows the topology or available set of resources in the server layer network and knows which nodes users of a client layer service primarily use for communications. The offline optimization tool uses this information to determine nodes at which to deploy the client layer resources. However, use of offline optimization tools limits the amount of dynamic reconfiguration that can be supported by the network. Dynamic reconfiguration may occur as a result of a service request interface being provided to the customer. The customer may have a limit to the amount of time the network can take to add another edge node to the service being provided which offline optimization may not be able to achieve. Additionally, the offline optimization tool may be unable to take into account the current configuration of the network providing connectivity between edge nodes, causing a significant amount of chum in the networks configuration impacting the service performance perceived by the customer.

### SUMMARY OF THE INVENTION

An example embodiment of the present invention is a method of managing network communications layers on a network. The example embodiment (i) selects nodes in a network normally configured with server layer resources to support client communications on a communications path between source nodes and destination nodes and (ii) instantiates client layer resources to support communications at branch nodes among the selected nodes at which communications paths from a common source node split to take different paths toward different destination nodes or at which communications paths toward a common destination node merge from different source nodes.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of a network in which example embodiments of the present invention may be employed;

FIGS. 2A-1-2D-2 are network diagrams illustrating example communications paths through a network and nodes defined as branch points based on the communications paths;

FIG. 3 is a flow diagram of an example embodiment of the present invention;

FIG. 4 is a flow diagram optionally employed at a node within the network; and

FIGS. 5A and 5B are network diagrams with nodes and signals according to example embodiments of the present invention.

### DETAILED DESCRIPTION OF THE INVENTION

A description of example embodiments of the invention follows.

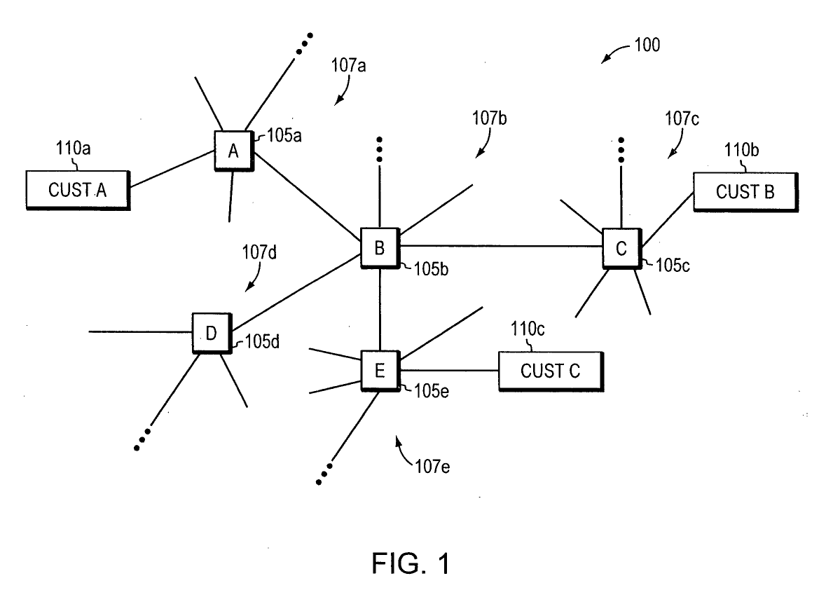

FIG. 1 is an example network 100 (a server layer network) that may employ example embodiments of the present invention. The network 100 includes network nodes 105a-e that are part of respective star topology subnetworks 107a-e within the network 100. Customers 110a-c may communicate via the network 100 across a subset of the subnetworks 107a-e and, consequently, a subset of the network nodes 105a-e. The customers 110a-c may use Ethernet communications (a client layer) and, thus, efficiency or other improvements over server layer communications can be gained by using client layer resources. In this example, a node 105b, which is a hub node among the subnetworks 107a-e, is a good choice to instantiate client layer resources, such as Ethernet switching to provide layer 2 communications, which support point-to-multipoint or multipoint-to-multipoint connectivity more efficiently than the server layer. In the descriptions that follow the term “client layer resources” is used to generally represent any of the client layer switching, bridging, cross-connection, adaptation to/from a server layer or other client layer functions that may be required to satisfy a client layer service request.

Client layer services, such as Ethernet services, may be provided by networks that provide server layer services, such as Synchronous Optical Network/Synchronous Digital Hierarchy (SONET/SDH) services. Example embodiments of the present invention covers cases in which client layer services are provided among multiple points at the edge of a network that also provides server layer services, where client layer resources may be flexibly instantiated at nodes within the server layer services network. Some example cases include Ethernet services provided within SONET/SDH networks. Ethernet services provided within Multiprotocol Label Switching (MPLS) networks, low order SONET/SDH virtual private networks provided within SONET/SDH high order networks, etc. An issue that arises in such a situation is where to locate client layer resources to support the client layer services but not use the resources in a wasteful manner, since wasteful processing would use processing otherwise available for server layer resources. In such a network situation, example embodiments of the present invention may be (1) a method for identifying a need for client layer resources (e.g., Ethernet bridging or switching) and (2) a method for instantiating the client layer resources after usefulness at a given node has been identified.

A problem with offline optimization typically used to identify nodes to locate the client layer resources is that there is a dynamic nature of users subscribing to client layer services, such as Ethernet or Internet Protocol (IP) services. For example, Ethernet is generally not a service that a user subscribes to once and never subscribes to again. Of course, this static subscription behavior may occur for a small number of Ethernet subscribers, but that is not a dominant subscription behavior. As a result of dynamic subscriptions, a place in the network that the client layer resource should be appropriately located in order to provide client layer service may change over time. Accordingly, if a service provider has a slightly different deployment mode, such that there is, for example, unlimited client resource (e.g., Ethernet switching) available at every node in the network where one can interconnect server layer services (e.g., SONET/SDH), there is a possibility of bringing the Ethernet resource into use, thereby allowing the service provider to optimize Ethernet resource utilization. However, such broad use of Ethernet resources is wasteful.

It can be, though, that an Ethernet service provider is constrained in the number of service instances that it can support at a particular node in the server layer network. In this case, the service provider may not want to have the Ethernet resource enabled all the time. Instead, the service provider may want to enable and use the Ethernet resource on an as needed basis.

Ethernet service is an example of a client layer service used as an example throughout the example embodiments described herein. It should be understood that any client layer service (i.e., any service at a layer above the server layer) is within the scope of at least some embodiments of the present invention. Furthermore, SONET/SDH is an example of a server layer service used as an example throughout the example embodiments described herein. It should be understood that any server layer services (i.e., any service at a layer below the client layer) is within the scope of at least some embodiments of the present invention.

An example embodiment of the present invention determines where to locate client layer resources based on traffic demands. For example, a customer may say, “now I am interested in joining a Local Area Network (LAN) and having an Ethernet switching point established,” but does not want to wait for an offline tool to establish where the Ethernet switching location should be. The customer would rather have this established dynamically (i.e., in a substantially real-time manner).

Another example embodiment of the present invention treats this problem as a routing problem. This embodiment determines how to communicate from a source point to all the points in the Ethernet environment. To do so, a network node may calculate a tree representing paths, coming back towards the source point, from all the points with which the source point wants to communicate. This calculation is done not just for the source point, but for all the points that the source point can communicate within the LAN environment.

The tree may indicate that there are branches in the tree that are common for two different source or destination points. “Walking back” through those branches from the common point toward the source or destination points, the example embodiment of the present invention finds nodes where the branches start to diverge from one another, interchangeably referred to herein as “branch divergence points” or simply “branch points.” These branch points may be nodes where communication paths from a common source split to take different links towards different destinations or these branch points may be nodes where communication paths toward a common destination are merged from different sources. At a branch divergence point or at a node other than the branch divergence point, the example embodiment considers whether to place client layer resource(s) (e.g., Ethernet bridging) at the branch divergence point. So, this example embodiment of the present invention can generally be described as (1) identification of branch divergence points, optionally using trees, and (2) configuration, via signaling or provisioning, of client layer resources, after identifying a location for them, to support client layer services.

Another example embodiment of the present invention takes advantage of the fact that signaling messages are sent in both directions between sources and destinations involved in a service. Thus signaling messages can be used to identify both nodes where communications paths from a common source split to take different routes and nodes where communications paths from different sources merge to a take a common route. Signaling messages following branches of the tree from a common destination toward different sources can identify branch points at which communications paths merge toward that destination. Signaling messages following branches of the tree from a common source toward different destinations can identify branch points at which communication paths split toward different destinations. This allows the same approach of following branches in the tree to be used to identify both splitting and merging branch points in the network. A similar approach can be used by a provisioning server to identify branch points in the tree in cases in which provisioning is used to establish the client layer resources in the server layer network.

Identification of the branch divergence point (i.e., case (1) above) can be fine tuned because calculating all source trees for every point that exists in the network is a lot of work. But, an example embodiment of the invention achieves this by using a signaling protocol effectively to identify the branch points. For example, if a node in the network wants to join a LAN, it calculates a tree rooted at itself and sends signaling messages into the network in the direction of all the nodes it wants to reach. As the signaling messages are communicated, each of the network nodes recognizes if it happens to be one of the branch divergence points. If so, nodes determined to be branch divergence points instantiate a client layer resource (e.g., loads or enables software or other mechanism(s) to provide Ethernet switching or bridging services). If not, the example embodiment does not instantiate the client layer resource(s), and the network nodes that are determined not to be branch divergence points continue using the server layer network resources. Once a network node has instantiated a client layer resource, it can use the branches to establish connections with the other client layer resources to provide the client layer connectivity and service. Moreover, the signaling messages may be separate from or included with the client or server traffic in the network.

This example embodiment of the present invention can thus be described as (1) identification of branch divergence points using the trees or other equivalent mechanisms, and (2) using a signaling or provisioning mechanism to instantiate client layer resources after identifying use for them.

In an example network using SONET technology, an example embodiment of the present invention may be used to provide Ethernet over SONET, where the SONET infrastructure provides point-to-point connections, and Ethernet switching is used to go between point-to-point connections to get to a final destination.

Another aspect of the present invention is provided through use of signaling (or provisioning) to instantiate client layer resources with, for example, a minimum bandwidth to be supported on a link. As a result, Quality-of-Service (QOS) guarantees can be provided within capabilities of existing signaling (or provisioning) techniques.

An embodiment of the present invention can be considered a heuristic solution for accommodating a customer, who wants to establish a communications path through a network, in a substantially real-time manner. An individual service request (e.g., “create a given path with a selected bandwidth via a set of network nodes”) can be used to locate a client layer resource. In such an embodiment, there are no forecast models generated offline. Further, removal of the client layer resource(s) and redeployment of the client layer resource(s) to another network node can be performed in the same substantially real-time manner using signaling or provisioning techniques.

Server layer services, such as SONET/SDH services, that provide one-to-one connectivity, point-to-point connectivity, ring connectivity, and so forth, can be overlaid with client layer services, such as Ethernet services, to support personal computers (PCs), servers, and so forth, that use Ethernet services. The cost for SONET/SDH is high for multipoint-to-multipoint connectivity provided without network administration via Ethernet. For example, ten people may want to be connected to an email server, data server, or content server, and SONET/SDH has to support ten communications paths throughout the network, whereas multicasting using client layer services is a more efficient technique. Since SONET/SDH is already deployed in service provider networks and it provides server layer (e.g., layer 1) communications, tens of thousands of SONET/SDH equipment is already available. Therefore, embodiments of the present invention can take advantage of that equipment.

For example, an Ethernet switch is a layer 2 communications switch that can be instantiated at network nodes that are connected with other network nodes via the SONET/SDH communications links. But, it is useful to be selective about where to place the client layer resources to conserve network resources in each of the network nodes. Example embodiments for selecting where to place the client layer resources are disclosed herein. It should be understood that embodiments of the present invention support other client layer services, such as layer 3 services, e.g., IP communications services.

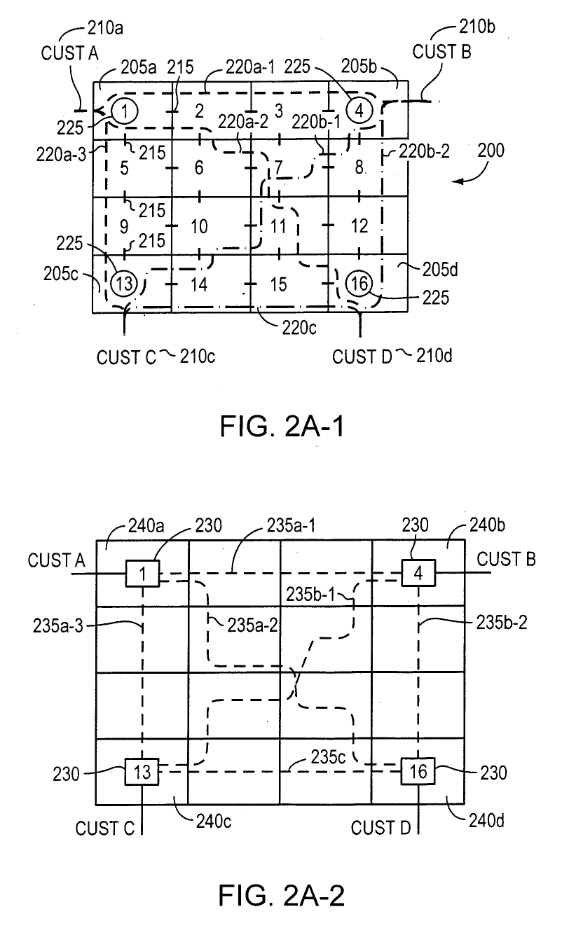

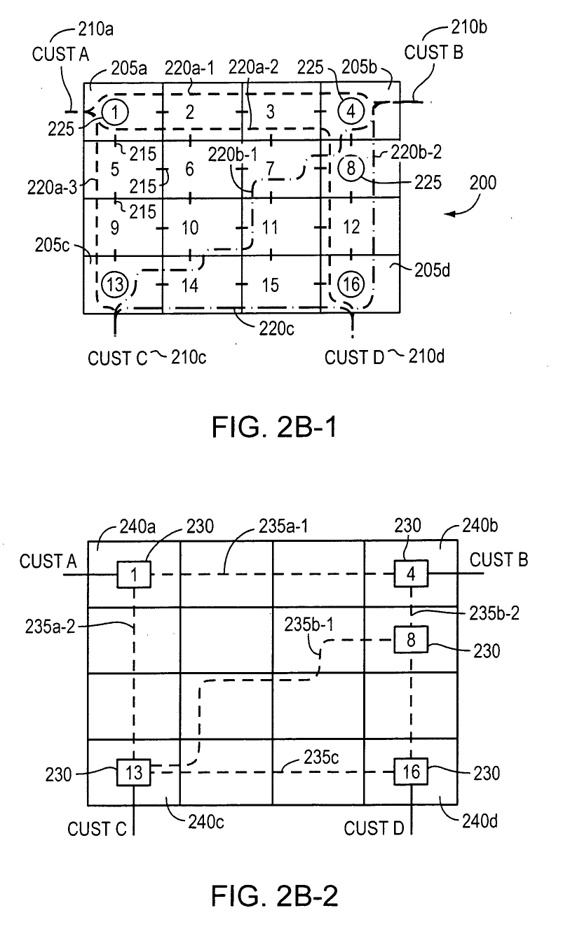

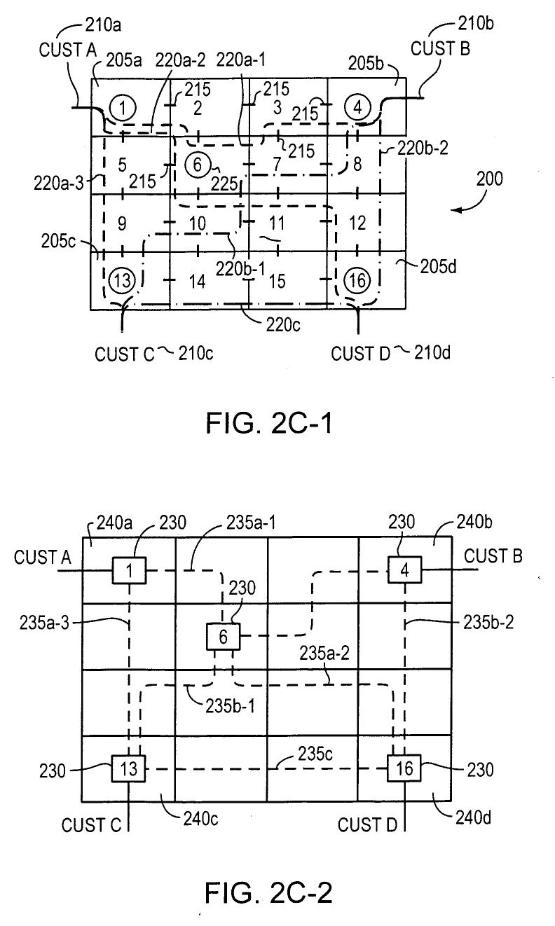

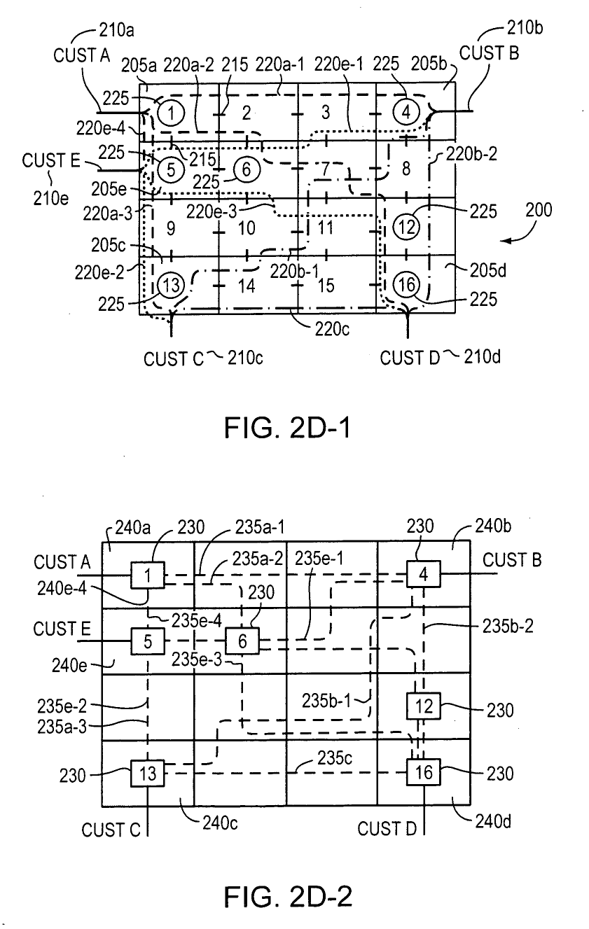

FIG. 2A-1 is a grid representing a network 200 of nodes 1-16 used to support communications between or among customers A-D 210a-d, respectively.

Various techniques for determining communications paths between customers via the nodes 1-16 to determine branch points in the network 200 may be employed according to an example embodiment of the present invention. For example, an Open Shortest Path First (OSPF) information gathering may be used to gather information to compute a tree. For example, an OSPF packet in an Internet Protocol (IP) network may provide information to all nodes the OSPF packet traverses sufficient for them to develop a complete topology map. The communication path trees may be computed from the topology map through use of a Dykstra shortest path algorithm, or other standard (or custom) algorithm, to identify a best path between any two points, such as customer A 210a and customer D 210d. The Dykstra algorithm is good for point-to-point path calculations, but not very good for multipoint-to-multipoint path calculations.

In accordance with embodiments of the present invention, a technique may be used to develop a tree map (“tree”) or other representation and to figure out where to instantiate client layer resources, such as an Ethernet bridge. A branch point is defined herein as a node in the tree where communications paths from one source or destination enters a node via one link and exit the same node via separate links. Although applicable to point-to-point path calculations, the example embodiments of the present invention presented herein add more value in point-to-multipoint or multipoint-to-multipoint environments.

Continuing to refer to FIG. 2A-1, edge nodes 205a-d are defined herein as nodes in the network 200 that serve as access points for respective customers 210a-d. Branches are defined as paths in a tree that extend outward from branch points. For example, in FIG. 2A-1, nodes 1, 4, 13, and 16 205a-d are branch points, and the branches, which in this case are all of the communications paths 220a-1, 220a-2, 220a-3, 220b-1, 220b-2, and 220c are illustrated as dashed lines, are computed by at least a subset of the nodes 1-16 (e.g., edge nodes A-D 205a-d). Where one path enters a node (e.g., node 1) and multiple paths (e.g., paths 220a-1, 220a-2, and 220a-3) exit the same node, a bridge or other client layer resource may be instantiated to support the multipoint communications.

Various techniques may be used to define paths through the network 200. A list of point-to-point links 215 in the network 200 to support communications between source and destination nodes (e.g., customers A-D 210a-d) may be used. Vertices in a graph, trees, or hash tables may be used to determine where to place Ethernet bridges or other client layer resources. A storage mechanism of any type may be used to store the tree, and a processor, either application-specific or general, in an edge node, for example, may be employed to make a determination as to a path to configure via the network from a source node to a destination node. Nodes supporting the path may autonomously determine to instantiate client layer resource(s), or edge nodes or a third party node may determine node(s) along the path at which to instantiate client layer resources and cause the node(s) to instantiate the client layer resources.

Further referring to FIG. 2A-1, communications paths between customer A 210a and customers B, C, and D 210b-d may be determined using an OSPF technique, as known in the art and described above. Through use of such a technique, three paths 220a-1, 220a-2, and 220a-3 may be determined. Similar path determination techniques can be used by customer B 210b to determine paths from itself to customers A 210a, customer C 210c, and customer D 210d, namely paths 220a-1, 220b-1, and 220b-2, respectively. Similarly, customer C 210c can use similar techniques to determine paths from itself to the other customers 210a, 210b, and 210d; specifically, a new path 220c between customer C 210c and customer D 210d is illustrated. It should be understood that factors, such as link rate, congestion, load, priority, or other factors well known in the art may cause the example paths 220a-1 . . . 3, 220b-1, 2, and 220c to take different routes from those illustrated.

Viewing the paths created among the customers 210a-d, a tree can be computed by any of the network nodes. In an example embodiment of the present invention, edge nodes 1, 4, 13, and 16 205a-d compute trees in support of their respective customers for which they provide access to the network. Thus, edge node 1 may compute a communications tree (or other representations) of the network 200 to determine branch divergence points among the network nodes 1-16.

In one operations example, edge node 1 205a may cause a communications path to be formed through the network 200, such as via signaling nodes 2, 6, 7, 11, and 15 to support a communications path to edge node 16 205d. The communications path may be, for example, a layer 1 SONET/SDH path or a layer 2 Label Switched Path (LSP) or a Layer 3 Internet Protocol (IP) path. Nodes that support multiple communications paths may instantiate client layer communications at nodes along the path that are identified as branch points to support client layer communications. For example, a node that supports two communications paths with a common source or destination may be a branch point and a candidate node for instantiating client layer resources.

It is possible to instantiate client resources in nodes traversed by more than one communications path, regardless of whether the node is a branch point; however, this does not provide any benefit over simple server layer switching if no client communication paths are combined in server layer connections by either splitting or merging. Thus, it is useful to instantiate client layer resources at branch points. Furthermore, it may be practical to require more than two communications paths to traverse a branch point to reduce the number of nodes that instantiate only when three or more communications paths traverse a branch point. In this example, the third communications path may or may not share a source or destination with the other two paths that determine the branch point. In the following description, an example requirement for three communications paths at a branch point is used as the criterion for the instantiating client layer resource.

In the example network 200, the network nodes 1-16 have a rich set of server layer communications links 215 interconnecting each other, where the server layer communications links 215 may be optical communications links over which SONET/SDH communications travel between the nodes (e.g., between nodes 1 and 5, 1 and 2, 5 and 6, 2 and 6, and so forth). In an event a node supports, say, at least three server layer communications paths, illustrated at edge nodes 1, 4, 13, and 16 205a-d, the nodes may instantiate or be caused to instantiate client layer resources, such as for customers A and D to use layer 1 communications (e.g., a SONET/SDH path), such as communications path 220a-2 across the network.

The individual nodes 1-16 may be configured with software, that instantiate client layer resources in an event its respective node is a branch point and has been signaled or provisioned to support multiple (e.g., at least three) communications paths. Thus, the individual nodes 1-16 can operate autonomously or under direction via signaling or provisioning and support communications according to example embodiments of the present invention.

In FIG. 2A-1, the edge nodes 1, 4, 13, and 16 205a-d support at least three exiting communications paths with at least two sharing a common source or destination and can thus be referred to as “resource points” or simply “client points” 225, indicated by the circles around the numbers.

In FIG. 2A-2, the edge nodes 1, 4, 13, and 16 240a-d have instantiated client layer resources 230, indicated by the square boxes around the numbers. The client layer resources 230 have been signaled or provisioned to support at least three communications paths. In FIG. 2A-2, the client layer resources 230 support all of the client layer communications paths 235a-1, 235a-2, 235a-3, 235b-1, 235b-2, and 235c, which are illustrated as dashed lines.

FIG. 2B-1 is a grid representing the network 200 of nodes 1-16 used to support communications between or among customers A-D 210a-d, respectively, via network nodes 1-16 in the network 200. The difference between the network diagram of FIG. 2A-1 and FIG. 2B-1 is that, in FIG. 2B-1, the network path 220a-2 takes a different route. Specifically, the network path 220a-2 from customer A 210a to customer D 210d travels from edge node 1 to edge node 16 via nodes 2, 3, 4, 8, and 12. This network path 220a-2 is a third communications path (i.e., paths 220a-2, 220b-1, and 220b-2) supported by node 8, in comparison to FIG. 2A-1 in which node 8 supported only two communications paths. Furthermore, node 8 is a branch point with respect to communications paths to/from customer B 210b (i.e., paths 220b-1 and 220b-2) and customer D 210d (i.e., paths 220a-2 and 220b-2). Therefore, in FIG. 2B-1, node 8 is defined as a client resource point 225 in this example embodiment, and client layer resources are instantiated at node 8 to support client layer communications.

In FIG. 2B-2, the edge nodes 1, 4, 13, and 16 240a-d have instantiated client layer resources 230, indicated by the square boxes around the numbers. The client layer resources 230 have been signaled or provisioned to support at least three communications paths. In FIG. 2B-2, the client layer resources 230 support all of the client layer communications paths 235a-1, 235a-2, 235b-1, 235b-2, and 235c, which are illustrated as dashed lines. Furthermore, node 8 is a branch point and has instantiated client layer resources 230 with respect to client layer communications paths to/from customer B (i.e., client layer communications paths 235b-1 and 235b-2) and customer D (i.e., client layer communications paths 235a-1 and 235b-2).

FIG. 2C-1 is a grid illustrating another example network 200 in which communications paths between customers A-D 210a-d are determined and signaled or provisioned in nodes 1-16 of the network. In this example, the network path 220a-1 between customer A 210a and customer B 210b circumvents a link 215 between network nodes 2 and 3, possibly due to network congestion, failed link, or other typical reason a communications path, such as a link switched path, is configured to take a longer route between a pair of nodes. In this example, the communications path 220a-1 from customer A 210a to customer B 210b travels through nodes 1, 2, 6, 7, 3, and 4. Further, the network path 220a-2 from customer A 210a to customer D 210d and the network path 220b-1 from customer B 210b to customer C 210c pass through network node 6. Accordingly, through use of a tree analysis or other form of communications path analysis, a client point 225 is defined at node 6 because, in this embodiment, at least three network paths traverse node 6 and two are from customer A 210a, making node 6 a branch point for these paths. Therefore, node 6 instantiates client layer resources in this embodiment.

It should be observed that, due to path changes of communications network paths 220a-1 and 220a-2 in FIG. 2C-1 from the example of FIG. 2B-1, node 6 became a client point, and node 8 reverted back to being a non-client point. Thus, in the configuration of FIG. 2C-1, node 6 operates with client layer resources, and node 8 operates with server layer resources.

In FIG. 2C-2, the edge nodes 1, 4, 13, and 16 240a-d have instantiated client layer resources 230, indicated by the square boxes around the numbers. The client layer resources 230 have been signaled or provisioned to support at least three communications paths. In FIG. 2C-2, the client layer resources 230 support all of the client layer communications paths 235a-1, 235a-2, 235a-3, 235b-1, 235b-2, and 235c, which are illustrated as dashed lines. Furthermore, node 6 is a branch point and has been instantiated client layer resources 230 because at least three client layer communications paths traverse node 6 and two are from customer A.

FIG. 2D-1 is a grid representing the network 200 illustrating yet another example operations embodiment. In this example, a new customer, customer E 210e is coupled to the network 200 via an edge node 205e. New link paths 220e-1, 220e-2, 220e-3 and 220e-4 are signaled or provisioned via network nodes 1-16, using techniques as described above. Based on the additional communications paths and communications paths previously defined among customers A-D 210a-d, nodes 1, 4, 6, 12, 13, and 16 are defined as client points 225. Note that node 7 is not a client point in this case because, while it is traversed by three communication paths, it is not a branch point as no two paths follow the same route from a source or destination and branch at node 7. Again, the nodes defined as branch points 225 may be autonomous in the sense that they have their own software that identifies when they are a branch point supporting at least three, for example, communications paths traversing themselves and, thus, instantiate client layer communications resources in an automated manner.

In FIG. 2D-2, the edge nodes 1, 4, 5, 12, 13, and 16 240a-e have instantiated client layer resources 230, indicated by the square boxes around the numbers. The client layer resources 230 have been signaled or provisioned to support at least three communications paths. In FIG. 2D-2, the client layer resources 230 support all of the client layer communications paths 235a-1, 235a-2, 235b-1, 235b-2, 235c, 235e-1, 235e-2, 235e-3, and 235e-4, which are illustrated as dashed lines. Furthermore, node 6 is a branch point and has instantiated client layer resources 230 because at least three client layer communications paths traverse node 6.

Instantiating client layer resources is defined herein as loading or executing software, optionally distributed via the server layer communications links 215, in a software embodiment, or enabling hardware or firmware in other embodiments, to support client layer services, such as Ethernet bridging services.

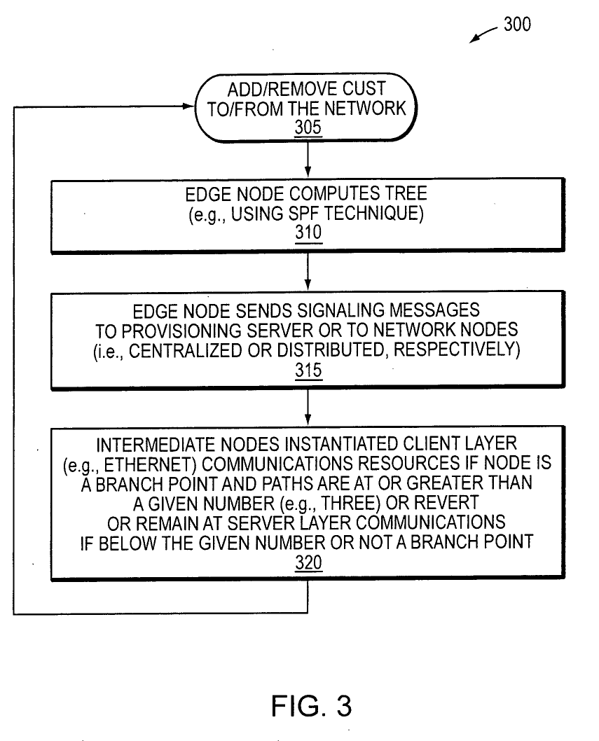

FIG. 3 is a flow diagram illustrating an example embodiment of the present invention. The flow diagram 300 begins (305) when a customer is added to or removed from the network. In either case, an edge node or other node computes a tree (310), such as through use of a Shortest Path First SPF technique. The edge node may thereafter send signaling messages to a provisioning server or directly to network nodes to set-up a communications path, such as a SONET/SDH path (315). Sending a signaling message to a provisioning server is referred to herein as a “centralized” technique for configuring a communications path in a network. Sending signaling messages directly to the network nodes is referred herein to as a “distributed” technique for configuring a communications path in a network. Intermediate nodes (i.e., nodes in the network via which the communications paths traverse the network) instantiate (320) client layer (e.g., Ethernet) resources if the criteria for instantiating client layer resources are met, for example, the node is a branch point and paths are at or greater than a given number (e.g., at least three), and or revert back to or remain using server layer resources if the criteria for instantiating client layer resources are not met, for example, paths are below the given number or the node is not a branch point. The flow diagram 300 may loop thereafter.

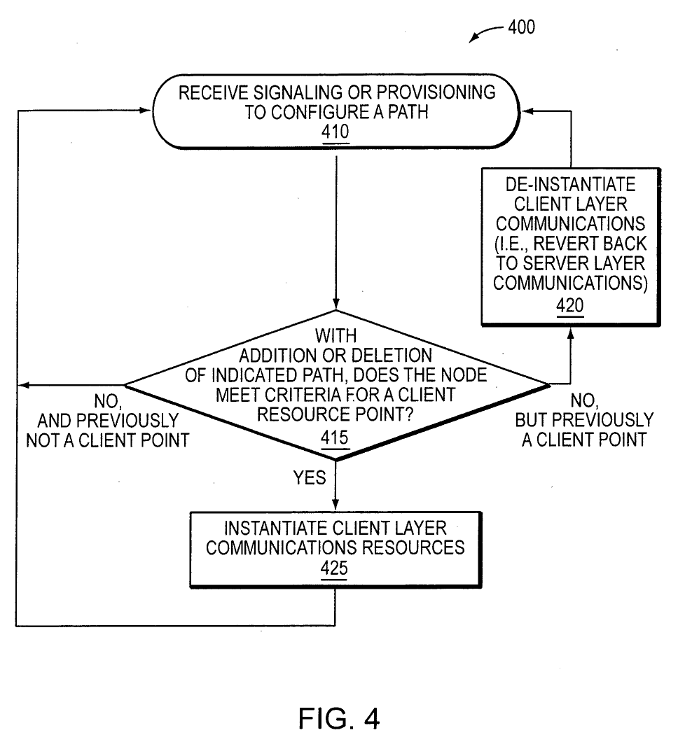

FIG. 4 is a flow diagram 400 of an example embodiment of the present invention executed in a node that has server and client layer resources available. The flow diagram 400 starts when signaling or provisioning is received to configure a link via the node (410). Note that this signaling or provisioning can be for the initial establishment of a client service, modification of a client service, or recovery of a client service in response to a network fault. A determination is made as to whether the node meets the criteria for a client resource point (415), for example, the number of paths supported are at or exceed a given number (e.g., three) and the node is a branch point. If the node does not meet the client resource point criteria and is not currently a client resource point, the flow diagram perform normal server layer path provisioning and returns to wait to receive signaling or provisioning to configure another path (410). If the node is a client resource point, but, as a result of the signaling or provisioning, no longer meets the criteria for a client resource point, the flow diagram de-instantiates client layer resources (i.e., reverts back to server layer communications) (420). Following the reversion (420), the flow diagram 400 waits for further signaling or provisioning (410). If the node meets the criteria for a client resource point, the flow diagram 400 instantiates client layer communications resources (425), then returns to wait to receive signaling or provisioning to configure another path (410). It should be understood that if client layer resources are already instantiated, there may be cases that no additional instantiation is needed.

It should be further understood that the flow diagrams of FIGS. 3 and 4 are merely exemplary, and other configurations, arrangements, additional blocks, fewer blocks, and so forth are possible in other embodiments. Further, the flow diagrams may be implemented in the form of software, firmware, or hardware. In the case of software, the software may be written in any language suitable for performing the embodiments disclosed herein. The software may be stored on any form of computer readable media, such as RAM or ROM, and loadable and executable by an application-specific processor or general purpose processor. Further, the software may be downloaded to nodes in a network via any form of network link, including wired, wireless, or optical links, via any form of communications protocol, optionally via a management network.

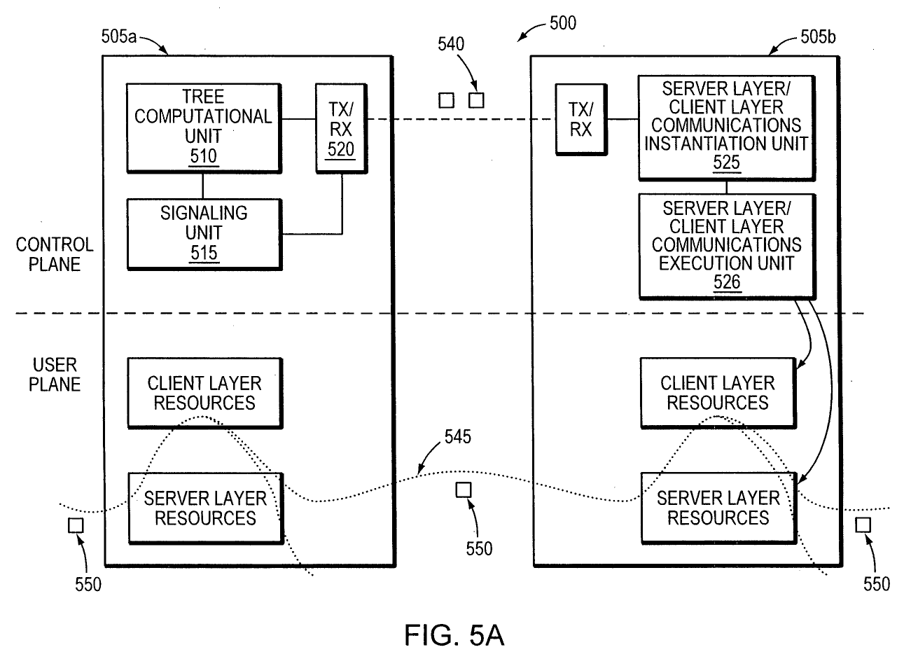

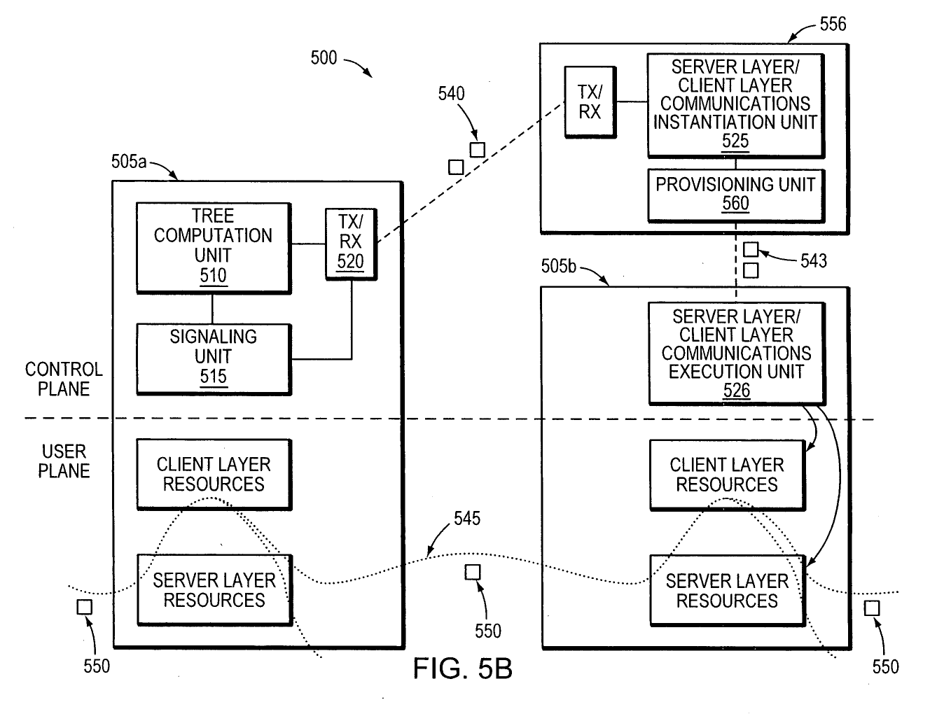

FIG. 5A is a network diagram of an example network 500 including an edge node 505a and an internal node 505b. The edge node 505a includes a tree computation unit 510, signaling unit 515, and transmit/receive unit 520. The internal node 505b includes a transmit/receive unit 520 and a server layer/client layer communications instantiation unit 525. It should be understood that either or both the edge node 505a and internal node 505b may include additional processors or units performing other aspects of network node operations, as is understood in the art. In other embodiments, the tree computation unit 510 and signaling unit 515 may be software or hardware integrated in other configurations. Similar alternative embodiments may be used for the server layer/client layer communications instantiation unit 525.

In one embodiment of the present invention, the edge node 505a may receive a link request 502 from a client node (not shown). Responsively, the request is provided to the tree computation unit 510 within edge node 505a to compute a tree representing the network, including determining a path to configure in the network to support communications between the client node (not shown), to which the edge node 505a is connected, and a destination node (not shown). The tree computation 510 utilizes the network topology known to node 505a. This topology information may have been developed using a routing protocol, for example, the OSPF routing protocol. The tree computation unit 510 may forward parameters or other information (not shown) to the signaling unit 515, which, in turn, generates communications path signaling 540 transmitted by the transmit/receive unit 520 to the internal node 505b, received by its transmit/receive unit 520.

Following receipt of the communications path signaling 540, the server layer/client layer communications instantiation unit 525 makes a determination as to whether, based on the communications path signaling 540, the internal node 505b has been selected to provide services for a communications path 545. If the internal node 505b has been selected, the server layer/client layer communications instantiation unit 525 may then determine whether to instantiate client layer resources or remain using or reverting to server layer resources. Instantiating client layer resources may be done if a branch point exists where the number of communications paths exceeds, for example, three. The given number, sometimes referred to as a threshold, may be set differently, but if set too high, there may be disconnected sets of nodes. In one embodiment, a preferred number is three to ensure there are few or no disconnected sets of nodes and also to reduce backhauling (i.e., bridges may be used to reduce backhauling capacity that is used in a network).

Once the server layer/client layer communications instantiation unit 525 has determined that client resources should be instantiated or de-instantiated, the action is communicated to the server layer/client layer execution unit 526.

After the communications path signaling 540 occurs and server layer or client layer resources are instantiated or de-instantiated, a communications path 545, such as a SONET/SDH path, is activated, and client layer communications 550 can flow in a uni- or bi-directional manner.

FIG. 5B is a network diagram including the edge node 505a and internal node 505b of FIG. 5A, but further includes a central provisioning server 555 housing the tree computation unit 510, server layer/client layer instantiation unit 525 and a provisioning unit 560. During operations, the signaling unit 515 sends communications path signaling 540 to the central provisioning server 555. Responsively, the tree computation unit 510 generates a shortest path tree from the source node to the destination nodes indicated in the service request, and the server layer/client layer instantiation unit 525 analyzes the tree to identify the locations to instantiate client layer resources. The provisioning unit 560 generates provisioning signal(s) 543 to send to the server layer/client layer execution unit 526 located within nodes in the network, including the internal node 505b, to provision communications paths including, for example, a SONET/SDH path 545 to support client layer communications 550.

As understood in the art, the embodiment of FIG. 5A is a “distributed” embodiment in which an edge node 505a signals internal nodes to configure resources to support various communications protocols, and the embodiment of FIG. 5B is a “centralized” embodiment in which a central provisioning server 555 is employed to cause the internal nodes to provide communications resources to support requested communications links. In both cases, it can be said that the edge node 505a causes the internal node 505b to instantiate or de-instantiate resources for supporting network communications.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of managing network communications layers in nodes in a network, the method comprising:
selecting nodes in a network normally configured with server layer resources to support client communications on a communications path between source nodes and destination nodes; and
instantiating client layer resources to support communications at branch nodes among the selected nodes at which communications paths from a common source node split to take different paths toward different destination nodes or at which communications paths toward a common destination node merge from different source nodes.

2. The method according to claim 1 wherein selecting the nodes comprises:
computing a tree representing the nodes in the network based on information provided by signals used to collect network information between a source node and at least one destination node; and
selecting the nodes to support the client layer communications from among the nodes represented in the tree.

3. The method according to claim 2 wherein computing the tree is performed in advance of establishing communications between the source node and at least one destination node, and further including causing a communications path to be formed via the nodes with client layer resources.

4. The method according to claim 3 wherein causing the communications path to be formed includes signaling or provisioning the nodes to configure the communications path.

5. The method according to claim 2 wherein computing the tree is performed in advance of establishing communications between the source node and at least one destination node and wherein instantiating client layer communications includes removing client layer communications in an event communications between the source node and destination node are discontinued.

6. The method according to claim 5 wherein removing the communications path includes signaling or provisioning the nodes to remove the communications path.

7. The method according to claim 1 further including specifying client layer parameters for use in establishing communications paths between the source node and destination node.

8. The method according to claim 1 wherein instantiating the client layer resources to support communications includes determining, at branch nodes, whether to instantiate client layer resources based on the number of communications paths that split or merge at the branch nodes.

9. The method according to claim 1 wherein instantiating the client layer resources to support communications occurs at branch nodes in an event at least two communications paths split or merge at each branch node.

10. A network supporting server layer and client layer communications, comprising:
a first node selecting second nodes in a network normally configured with server layer resources to support client communications on a communications path between source nodes and destination nodes; and
branch second nodes, among the selected second nodes, configured to instantiate client layer resources to support communications, the branch second nodes being nodes at which communications paths from a common source node split to take different paths toward different destination nodes or at which communications paths toward a common destination node merge from different source nodes.

11. The network according to claim 10 wherein the first node includes a tree computation unit to compute a tree representing the nodes in the network based on information provided by signals used to collect network information between a source node and at least one destination node and to select the nodes to support the client layer communications from among the nodes represented in the tree.

12. The network according to claim 11 wherein the tree computation unit is configured to compute the tree in advance of establishing communications between the source node and the at least one destination node, and wherein the first node further includes a signaling unit in communication with the tree computation unit that is configured to cause a communications path to be formed via the selected second nodes with client layer resources.

13. The network according to claim 12 wherein the signaling unit is configured to use signaling to cause the selected second nodes in the tree to configure a communications path through the network or communicates with a provisioning server in the network that provisions the second nodes to configure a communications path.

14. The network according to claim 12 wherein the tree computation unit is configured to compute the tree in advance of the signaling unit to establish communications between the source node and at least one destination node and, in an event communications through the network via the communications path are discontinued, the signaling unit is further configured to cause the branch second node to remove client layer resources.

15. The network according to claim 14 wherein the signaling unit is configured to use signaling to remove the client layer communications at the branch second node or communicates with a provisioning server that provisions the branch second node to remove the client layer communications.

16. The network according to claim 14 wherein the signaling unit is configured to specify client layer communications parameters and forwards them to the branch second node for use during establishment of paths supporting the client layer communications.

17. The network according to claim 10 wherein the branch second node includes a server layer/client layer communications instantiation unit that is configured to determine to instantiate the client layer resources based on the number of communications paths that split or merge at the branch second node.

18. The network according to claim 10 wherein the number of communications paths at the branch second node is equal to at least two.

19. A method of managing network communications layers on a network, the method comprising:
dynamically enabling or disabling client layer resources at nodes normally configured with server layer resources based on identification of branch nodes at which communications paths from a common source node split to take different paths toward different destination nodes or at which communications paths toward a common destination node merge from different source nodes and a number of communications paths that split or merge at each branch node.

20. The method according to claim 19 wherein the number of communications paths is at least two.

21. The method according to claim 19 wherein the client layer supports Ethernet links and bridging or switching and the server layer supports point-to-point connections.

22. The method according to claim 21 wherein the point-to-point connections use SONET/SDH.

23. The method according to claim 19 wherein dynamically enabling or disabling client layer communications is performed by signaling the nodes in server traffic or separate from server traffic.

24. The method according to claim 19 wherein dynamically enabling or disabling client layer communications includes:
computing a tree representing the network and network nodes that are branch nodes;
sending at least one signal to a provisioning node; and
provisioning the nodes that are branch nodes or are no longer branch nodes in a manner causing the nodes to dynamically enable or disable client layer resources.
